(19) United States
(12) Patent Application Publication
(10) Pub. No.: US 2004/0089179 A1
(43) Pub. Date: May 13, 2004

(54) Device and method for cleaning a printing carrier before each printing cycle

(76) Inventor: Robert Link, Munchen (DE)

Correspondence Address: SCHIFF HARDIN, LLP, PATENT DEPARTMENT, 6600 SEARS TOWER, CHICAGO, IL, 60606-6473, US

(21) Appl. No.: 10/451,284

(22) PCT Filed: Nov. 6, 2001
(86) PCT No.: PCT/EP01/12828

(30) Foreign Application Priority Data
Dec. 21, 2000 (DE) 100 63 987.9

(51) Int. Cl. B41F 35/00

(52) U.S. Cl. 101/424

(57) ABSTRACT

The invention relates to a device and method for cleaning a printing carrier in which the printing carrier (10) is cleaned before each printing cycle and, in turn, before applying new image information. In order to clean the printing carrier (10), the printing carrier is subjected to the action of a cleaning fluid. A digital method is preferably used for structuring.

The invention concerns a device to clean a printing medium, in that the printing medium is structured such that it carries new image information for each print cycle that is inked with ink material that is printed upon a medium, for example paper or an intermediate carrier. Furthermore, the invention concerns a method to clean a print medium.

Printing methods in which the printing medium is newly structured by a digital method for each print cycle are known from WO 98/32608, WO 97/36746, and U.S. Pat. No. 5,067,404 from the same applicant. For example, the surface of the printing medium is structured in WO 98/32608 such that ink-attracting and ink-repelling regions exist. A substance present in the solid phase, preferably water, is used as an ink-repelling medium is generated thereon by cooling the surface of the printing medium. After the ink material is transfer printed to the paper, the surface of the printing medium is cleaned of ink residue. The printing medium is then structured anew and carries new image information. A digital method is used in the structuring, for example using the radiation of a laser, a laser diode, an LED or an LED array. In a method according to the WO 97/36746, a thin moisture film is generated every print cycle on the surface of the printing medium by charging the surface with water vapor, and subsequently the structuring of the moisture film is undertaken. The aforementioned documents are herewith included by reference in the disclosure of the present patent application.

Further methods and printing devices to print a medium material and to clean a print roller are known from the PCT patent applications with serial numbers PCT/EP00/06028 and PCT/EP00/06026 by the same applicant. A multiplicity of depressions are present on the surface of a printing medium for the acceptance of printing fluid. Ink material is placed in these depressions with the aid of an inking station. The printing fluid contained in the depressions is used to print on a printing medium at a transfer printing location. With the aid of a digital method, every print cycle the print fluid in the depressions is dealt with in such a manner that a portion of the print fluid is transfer printed at the transfer printing location, and another portion remains in the depressions. Both of these cited documents are also herewith included by reference in the disclosure of the present patent application.

It is necessary in the cited printing methods that, before applying new image information to the surface of the printing medium, this surface is cleaned of ink residues and other substances. The cleaning process must be of such a nature that it can be included in the printing process without problems, in particular upon consideration of the structuring of the surface of the printing medium with the aid of a digital method. As a result, the cleaning duration must be short, and a large number of cleaning cycles should be possible for the same cleaning medium.

The object of the invention is to specify a device and a method to clean a printing medium that can be included in a simple manner in the printing process and that work with a short cleaning duration.

The object is achieved by the invention according to the features of claim 1. Advantageous developments are given in the sub-claims.

The cleaning fluid is preferably comprised of water; if need be, cleaning additives are present. An intermediate carrier can be present as well as a printing medium upon which the image information from a first printing medium is transferred. A cleaning device according to the invention can be arranged at both a first printing medium and at an intermediate carrier. These measures make the overall printing process environmentally friendly and economical.

A method of cleaning a printing medium is given according to a further aspect of the invention.

Exemplary embodiments of the invention are explained in the following with drawings. Thereby shown are:

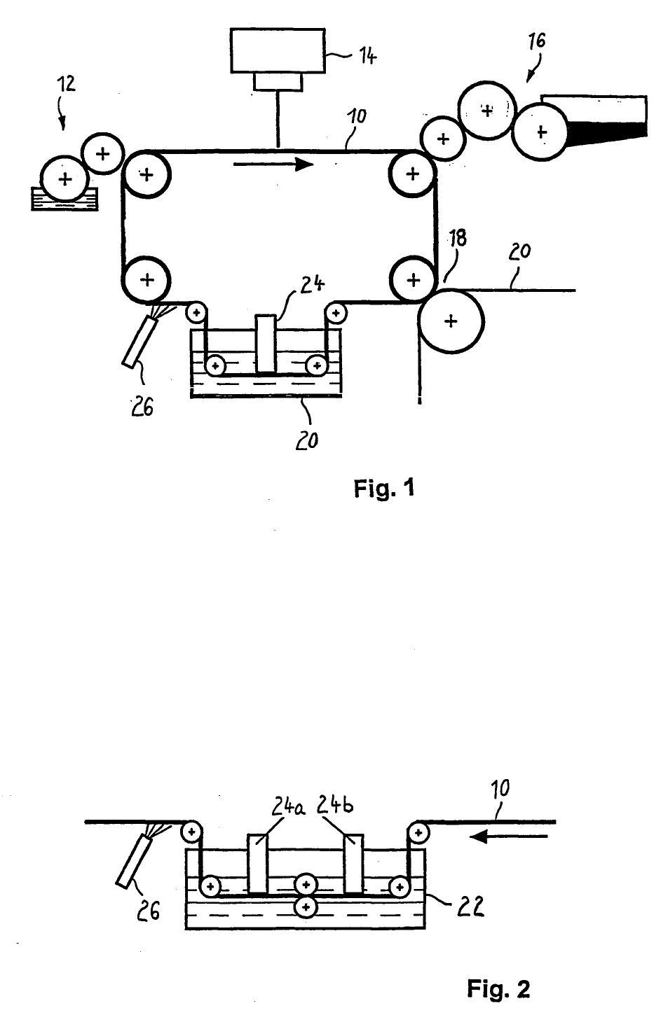

FIG. 1 schematic of a printing process with a band-shaped printing medium that is fed through an immersion bath with cleaning fluid,

FIG. 2 a similar arrangement as FIG. 1, with a multiple-stage ultrasonic charging of the band-shaped printing medium,

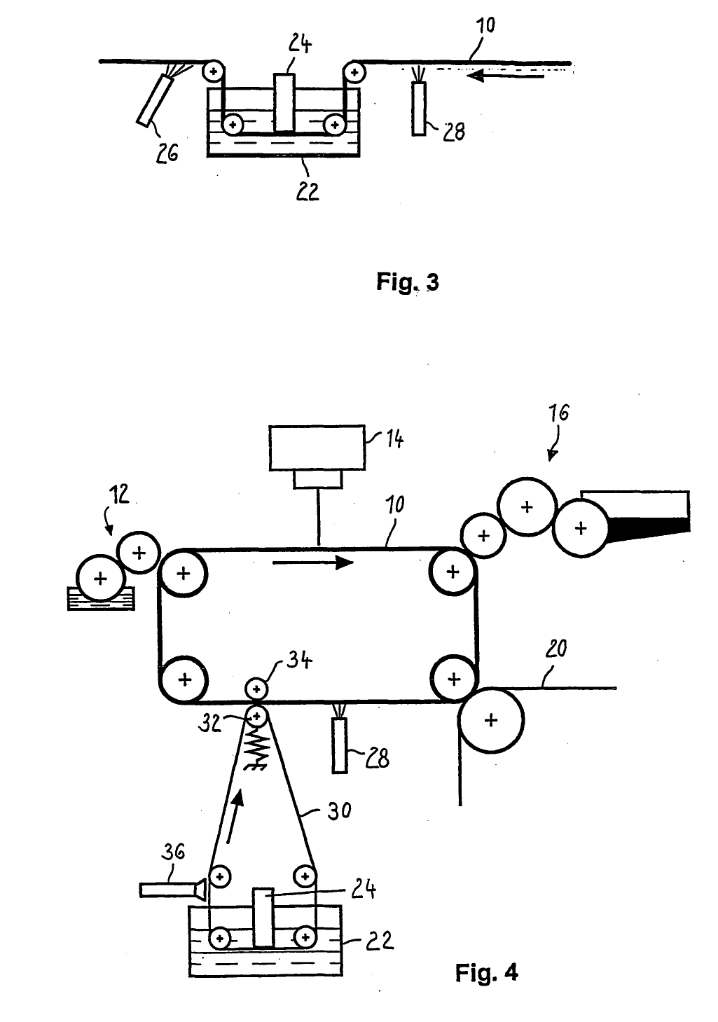

FIG. 3 a combination of high pressure cleaning and immersion bath for a band-shaped printing medium

FIG. 4 a design of a cleaning device with cleaning belt,

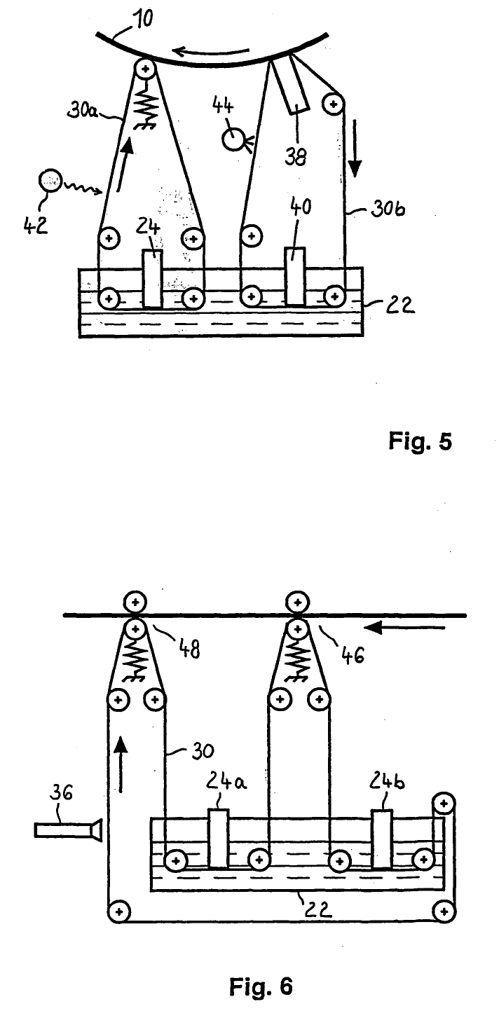

FIG. 5 a multi-stage cleaning process with two cleaning belt, and

FIG. 6 a multi-stage cleaning process with a single endless cleaning belt

FIG. 1 shows the basic design of a printer that structures the surface of a band-shaped printing medium 10 with the aid of a digital method. The band-shaped printing medium 10 is fed over a plurality of deflection rollers that are not individually referenced. An application station 12 applies a fluid film to the surface of the print medium. For example, this can occur as is described in the already cited U.S. Pat. No. 5,067,404 by the same applicant.

The surface of the printer medium 10 is structured with the aid of a structuring device 14 such that it carries new image information. For example, a structuring ensues such that ink-attracting and ink-repelling regions are generated with the aid of a laser beam according to a digital method. An ink application device 16 inks ink-attracting regions with ink material. The ink material is transfer printed at a transfer printing location 18 onto a medium 20, for example paper or an intermediate carrier. The band-shaped printing medium 10 is subsequently fed over deflection rollers and arrives in an immersion bath 22 with cleaning fluid. The cleaning fluid is comprised of water. The cleaning fluid is preferably comprised exclusively of water; if need be, cleaning additives are supplied. An ultrasonic actuator 24 charges the band-shaped printing medium 10 with ultrasonic energy, by means of which the separation of ink particles is accelerated. The ultrasonic actuator 24 can be arranged on both sides of the printing medium 10.

The cleaned printing medium is dried following the immersion bath 22, for example by a fan 26 and/or by a radiation source (not shown). The surface of the printing medium is then ready to be charged with a new moisture film by the application device 12. The print cycle can begin anew.

FIG. 2 shows a variant, wherein the band-shaped printing medium 10 undergoes a multi-stage cleaning in the immersion bath 22. Two ultrasonic actuators 24a, 24b are present, by means of which the cleaning effect is increased. In this case as well, each ultrasonic actuator 24a, 24b can act upon the back side (as shown) or upon the front side of the printing medium 10.

FIG. 3 shows a further variant, wherein a high-pressure cleaning device 28 is arranged that sprays a cleaning fluid under high pressure onto the surface of the band-shaped printing medium 10. A preliminary cleaning ensues in this manner. The subsequent final cleaning is undertaken in the immersion bath 22 under the effect of the ultrasonic actuator 24.

FIG. 4 shows a variant of the exemplary embodiment according to FIG. 1. Identical parts are identically designated. The band-shaped printing medium 10 does not itself traverse the immersion bath 22. Rather, a cleaning belt 30 is provided that is brought in contact with the band-shaped printing medium 10. With the aid of a spring-loaded pressure roller 32, the cleaning belt 30 presses against the printing medium 10 that in turn presses against a counter-pressure roller 34. The cleaning belt 30 is implemented as a conveyer belt or as a woven belt and provides for the removal of the ink particles.

The cleaning belt 30 is fed through the immersion bath 22 and is charged with ultrasonic energy from the ultrasonic actuator 24. After traversing the immersion bath 22, the cleaning band 30 is conducted past a suction device 36 which sucks off cleaning fluid. The cleaning by the cleaning belt 30 is preceded by the high-pressure cleaning device 28, with whose aid the ink residue is loosened from the printing medium.

FIG. 5 shows a multi-stage cleaning with the aid of two cleaning belts 30a, 30b. A drum is used here as the printing medium 10. The cleaning belt 30b effects a preliminary cleaning with the involvement of two ultrasonic actuators 38, 40. The ultrasonic actuator 38 acts on the printing medium 10. The ultrasonic actuator 40 acts on the cleaning belt 30b in the immersion bath 22. An application of cleaning fluid, for example water, ensues by agency of the water application device 44 before the cleaning belt 30b contacts the printing medium 10. The cleaning belt 30a is cleaned by use of the ultrasonic actuator 24. A heat source 42 dries the cleaning band 30a and charges its surface with heat energy. Both cleaning bands 30a, 30b rotate counter to the running direction of the printing medium 10.

FIG. 6 shows a further variant, wherein a single cleaning belt carries out the multi-stage cleaning. The cleaning belt 30 effects a preliminary cleaning at a first cleaning location 46 and a final cleaning at a second cleaning position 48.

The exemplary embodiments presented can be modified in many ways. For example, a rigid cleaning roller, whose surface comprises a tiled covering [sic], a woven covering, or bristles, can be used instead of a cleaning belt. Cleaning fluid can be removed from the coating of the cleaning barrel or the cleaning belt with the aid of pinch rollers. Alternatively, wiper elements and stripping elements can be used. The polluted cleaning fluid can be separated from the dirt particles with appropriate methods (for example filter methods, separation methods making use of centrifugal force or gravitational force) and newly supplied to the immersion bath in a recycling cycle.

In a further variant it is provided that, for example in the exemplary embodiments according to FIGS. 4, 5, and 6, the cleaning belt can be held a distance from the medium, such that no cleaning ensues. The image structure thus remains on the cleaning belt. The same image pattern can be newly transfer printed, given a new application of ink. The print cycle then comprises a plurality of transfer printing events. The print cycle then comprises a plurality of transfer printing procedures. If a new print cycle with a new image pattern is begun, the cleaning belt must again be brought in contact with the printing medium beforehand in order to clean its surface. A new image pattern can then be applied.

The specified cleaning devices can preferably be used in connection with a printing process as is specified in WO 97/36746. In this, hydrophobic and hydrophilic regions corresponding to the structure of the print image to be printed are generated on the surface of the printing medium. The surface is overlaid with a thin liquid film that moistens the hydrophilic regions. Ink is subsequently applied to the surface that adheres to the unmoistened regions and is not accepted by the moistened regions. The ink is transfer printed from there onto the medium material. The surface is charged with water vapor to generate the thin liquid film. The water vapor can preferably be transferred onto the surface by agency of a vaporization device arranged near the surface of the printing medium. The water vapor can also be generated by agency of a moistened fabric tape arranged near the surface of the printing medium, that is heated with the aid of a radiation source and/or a heat source, whereby the water vapor is transferred onto the surface.

The specified cleaning device can also be advantageously used in connection with a printing method specified in WO 98/32608. In this printing method, ink-attracting and ink-repelling regions corresponding to the structure of the printing image to be printed are generated on the surface of the printing medium. The ink-repelling regions are provided with a film made of an ink-repelling medium. Upon application of ink to the surface, it adheres to the ink-attracting regions; the ink is not accepted by the ink-repelling regions. The ink thus distributed on the surface of the printing medium according to the printing image is transfer printed to a medium material. A substance is used as an ink-repelling medium in the affixing phase that is generated on the surface if the printing medium by cooling. To generate the solid phase of the substance, preferably water, the printing medium is preferably cooled, at least on its surface, to a temperature below the solidification temperature of the substance. The print-active surface of the printing medium is next completely provided with a solid state layer, preferably an ice layer. In a digital structuring process, regions free of solids or, respectively, ice, are generated as ink-attracting regions corresponding to the structure of the printing image to be printing. A refrigerant system is preferably used to cool the printing medium. The ice layer of the surface of the printing medium is charged by radiation to form the ice-free regions, for example with the radiation of a laser, a laser diode, an LED, or an LED array. The ice-free regions can alternatively be generated by use of a heating element.

A further preferred possible field of application of the specified cleaning device can be used for printing methods that are specified in the PCT patent applications with serial numbers PCT/EP00/06028 and PCT/EP00/06026. The surface of the printing drums hereby has a plurality of depressions for the acceptance of printing fluid. An inking station delivers printing fluid to these depressions. With the aid of a digital structuring process, the surface tension of the printing fluid in the depressions is influenced corresponding to an image pattern to be printed. The printing fluid from the depressions corresponding to the image pattern is printed on the medium during the transfer printing. The printing fluid remains in the other depressions and is not applied to the medium. The specified cleaning devices are suitable to completely strip the printing fluid from the depressions, such that a complete cleaning of the surface of the printing medium is enabled. The latter are then ready to accept new printing fluid in the depressions, and a new structuring process and transfer printing process can ensue.

Further details of the specified printing method are found in the cited documents, whose contents hereby referenced are included in the contents of the disclosure of the present patent application.

### REFERENCE LIST

10 printing medium

12 application device

14 structuring device

16 ink-application device

18 transfer printing location

20 medium

22 immersion bath

24 ultrasonic actuator

26 blower

28 high-pressure cleaning device

30, 30a, 30b cleaning belt

32 pressure roller

34 counter-pressure roller

36 suction device

38, 40 ultrasonic actuators

42 heat source

44 water application device

46 preliminary cleaning device

48 end cleaning device

1. Device to clean a printing medium (10) in that the printing medium (10) is structured for each print cycle on its surface such that it carries new image information that is inked with in material,
the ink material is transfer printed to a medium (20),
the surface of the printing medium (10) is cleaned before the application of a new image information,
whereby the surface of the image medium (10) is charged with a cleaning fluid.

2. Device according to claim 1 characterized in that the structuring of the surface of printing medium ensues directly or indirectly with the aid of a digital method.

3. Device according to claim 1 or 2, characterized in that the cleaning fluid is comprised of water.

4. Device according to claim 3, characterized in that the cleaning fluid is comprised of water and, if need be, cleaning additives.

5. Device according to any of the preceding claims, characterized in that the surface of the printing medium (10) is charged with ultrasonic energy.

6. Device according to any of the preceding claims, characterized in that the surface of the printing medium (10) is charged with a high-pressure emission of cleaning fluid.

7. Device according to any of the preceding claims, characterized in that the band-shaped printing medium is led through an immersion bath (22) with cleaning fluid.

8. Device according to any of the preceding claims, characterized in that the cleaning ensues in a plurality of cleaning stages.

9. Device according to any of the preceding claims, characterized in that the surface of the printing medium (10) is at least brought in contact with a cleaning belt (30 in order to clean it.

10. Device according to claim 9, characterized in that the cleaning belt (30, 30a) is pressed against the surface of the printing medium (10) with the aid of a spring resistance.

11. Device according to claim 8 or 9, characterized in that the band-shaped printing medium (10) is applied to a counter-pressure roller (34).

12. Device according to an of the preceding claims, characterized in that the cleaning belt (30, 30a, 30b) is charged with ultrasonic energy.

13. Device according to an of the preceding claims, characterized in that the cleaning belt (30b) and the surface of the printing medium (10) is charged with ultrasonic energy.

14. Device according to any of the preceding claims, characterized in that the cleaning belt (30) is directed to a suction device (36) after traversing the immersion bath (22) with cleaning fluid.

15. Device according to any of the preceding claims, characterized in that the cleaning belt (30, 30a, 30b) is moved counter to the running direction of the printing medium (10).

16. Device according to any of the preceding claims, characterized in that the cleaning band (30a) is directed to a heat source (42) after traversing the immersion bath (22).

17. Device according to any of the preceding claims, characterized in that the cleaning belt (30b) is directed to a water application device (44) after traversing the immersion bat (22).

18. Device according to any of the preceding claims, characterized in that the cleaning process if multi-stages whereby a first cleaning belt (30b) effects a preliminary cleaning and a second subsequent cleaning belt (30a) undertakes the end cleaning.

19. Device according to any of the preceding claims, characterized in that a single endless cleaning belt (30) effects a multi-stage cleaning.

20. Device according to any of the preceding claims, characterized in that the cleaning belt is a conveyor belt or a fabric tape.

21. Device according to any of the following claims, characterized in that a cleaning roller is used in place of a cleaning belt, preferable one with a tile [sic] or woven covering.

22. Device according to any of the preceding claims, characterized in that the means are provided by which the surface of the printing medium is optionally brought in contact with the cleaning belt or the cleaning roller, and by which this contact is in turn reversed.

23. Device according to any of the preceding claims, characterized in that the printing medium is an intermediate carrier upon which the image information is transfer printed from first printing medium.

24. Method of cleaning a printing medium (10),
in that the printing medium (10) is structured for each print cycle on its surface such that it carries new image information that is inked with ink material,
that ink material is transfer printed to a carrier (20),
the surface of the printing medium (10) is cleaned before application of new image information,
whereby the surface of the printing medium (10) is charged with a cleaning fluid.

25. Method according to claim 24, characterized in that the structuring of the surface of the printing medium ensues with the aid of a digital method.

26. Method according to one of the claims 24 or 25, characterized in that the printing medium is an intermediate carrier upon which the image information is transfer printed from the first printing medium.
